(19) United States
(12) Patent Application Publication
(10) Pub. No.: US 2006/0291114 A1
(43) Pub. Date: Dec. 28, 2006

(54) Electrostatic discharge protection circuit and method

(76) Inventors: Chee Keong Teo, Singapore (SG); John Julius Asuncion, Singapore (SG); Kok Soon Yeo, Singapore (SG); Lian Chun Xu, Singapore (SG); Wal Keat Tai, Singapore (SG)

Correspondence Address: AVAGO TECHNOLOGIES, LTD., P.O. BOX 1920, DENVER, CO, 80201-1920, US

(21) Appl. No.: 11/166,176

(22) Filed: Jun. 27, 2005

(51) Int. Cl. H02H 9/00

(52) U.S. Cl. 361/56

(57) ABSTRACT

A circuit that protects against electrostatic discharge and electrical over stress is provided. The circuit includes a first transistor including a substrate. An internal predetermined voltage source biases the substrate of the first transistor. The internal predetermined voltage source is greater than or equal to a source voltage provided to a source of the first transistor and isolates a substrate voltage of the first transistor from a supply voltage of the circuit. A first resistor is coupled to a gate of the first transistor and ground. The circuit also includes a zener diode coupled between ground and the supply voltage of the circuit. The zener diode shorts to ground if the supply voltage of the circuit exceeds the breakdown voltage of the zener diode.

### TECHNICAL FIELD

The technical field relates to protection of a circuit against electrostatic discharge and electrical over stress.

### BACKGROUND

Light sensing technology exists in many industrial and consumer applications. For example, light sensing diodes are used in devices such as personal digital assistants (PDAs) and mobile phones to conserve power by turning off the backlight of the liquid crystal display (LCD) when the environmental ambient light is sufficient for visibility.

An example of a diode that may be used for detecting such ambient light conditions is a Positive-Intrinsic-Negative (P-I-N) diode. A P-I-N diode has a large intrinsic region between positive (p) and negative (n) doped semiconductor regions. P-I-N diodes can be used for sensing a wide range of input current from nano-Amps (nA) to milli-Amps (mA).

A light detection circuit may include a P-I-N diode coupled to an input metal-oxide-semiconductor (MOS) transistor. To reduce overall power requirements while simultaneously increasing the speed of the diode, MOS transistors use a thin silicon oxide layer separating the MOS gate from the MOS channel. This configuration makes MOS transistors susceptible to damage caused by external electrostatic discharge (ESD), or electrical over stress (EOS) at the terminals (i.e., gate, drain source or body) when MOS transistors are connected to an external power supply. A MOS transistor, such as a P-type MOS (PMOS) transistor, when exposed to ESD or EOS can experience breakdown of the silicon oxide layer separating the MOS gate from the MOS channel. Breakdown of the silicon oxide layer results in current leakage from the channel to the gate. Damage to the oxide layer may lead to decreased transistor performance, improper operation, or even total failure of the MOS transistor.

For a light detection circuit to accurately detect when sufficient ambient light conditions permit the backlight of, for example, a PDA, to be turned off, the P-I-N diode should not emit any current (stray or dark current). Consequently, an input differential PMOS should not have gate leakage from the channel. The leakage of current can cause the light detection circuit to falsely trigger or even fail. In other words, the light detection circuit may determine that the leaked current was caused by detection of sufficient ambient light and may generate an output to erroneously turn off the backlight of the PDA.

### SUMMARY

Disclosed is a circuit that protects against electrostatic discharge and electrical over stress. The circuit includes a first transistor including a substrate. An internal predetermined voltage source biases the substrate of the first transistor. The internal predetermined voltage source is greater than or equal to a source voltage provided to a source of the first transistor and isolates a substrate voltage of the first transistor from a supply voltage of the circuit. A first resistor is coupled to a gate of the first transistor and ground. The circuit also includes a zener diode coupled between ground and the supply voltage of the circuit. The zener diode shorts to ground if the supply voltage of the circuit exceeds the breakdown voltage of the zener diode.

### BRIEF DESCRIPTION OF THE DRAWINGS

FIG. 1 is a diagrammatic representation of a light sensing circuit.

FIG. 2 illustrates a two-stage trans-impedance amplifier including an embodiment of a protection circuit.

FIG. 3 illustrates a two-stage trans-impedance amplifier including a modified protection circuit.

FIG. 4 illustrates a two-stage trans-impedance amplifier including a modified protection circuit.

FIG. 5 illustrates a two-stage trans-impedance amplifier including a modified protection circuit.

### DETAILED DESCRIPTION

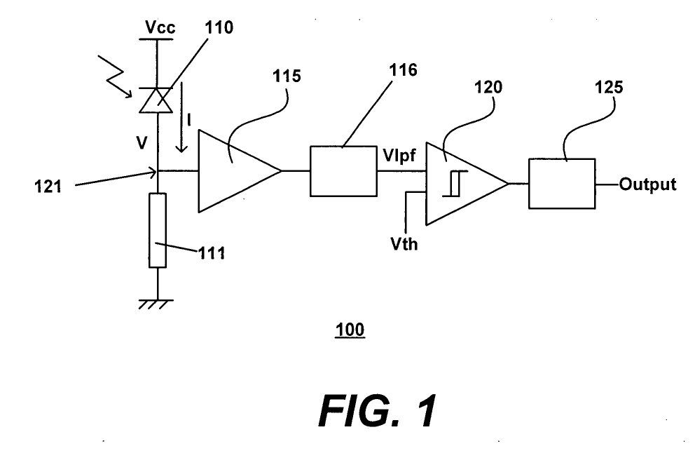

FIG. 1 is diagrammatic representation of a light sensing circuit 100 that incorporates a circuit designed to protect against external electrostatic discharge (ESD) or electrical over stress (EOS) (collectively referred to herein as “ESD/EOS”). As shown in FIG. 1, circuit 100 includes photodiode 110, resistor 111, amplifier 115, a low pass filter (LPF) 116, comparator 120 and an output stage 125.

In light sensing circuit 100, light exposure on the photodiode 110 results in a flow of photo current I which is converted into its voltage equivalent V at 121. Photodiode 110 may be a P-I-N diode. The light sensing circuit 100 may sense a dynamic range of current from nano-Amps (nA) to milli-Amps (mA). The voltage (V) at 121 is amplified by amplifier 115. The output from the amplifier 115 is input to the LPF 116. The LPF 116 allows frequencies below a certain threshold to pass while filtering out frequencies above the threshold. The voltage output by the LPF 116 (“Vlpf”) is input to comparator 120, which receives a second input, a threshold voltage Vth.

The comparator 120 compares Vlpf with Vth, and if Vlpf is greater than Vth, then output stage 125 will output a first output. The first output may, for example, indicate that the photodiode 110 senses enough ambient light to generate a voltage greater than the threshold voltage Vth. In this case, the first output provides a positive signal (e.g., a “high signal”) to a next stage (not shown) to turn off the backlight of a PDA, for example. Turning off the backlight helps to conserve the PDA's battery power.

If Vlpf output by the LPF 116 is less than Vth, the output stage 125 will output a second output. The second output may, for example, indicate that the photodiode 110 does not sense enough ambient light to generate a voltage greater than the threshold voltage Vth. In this case, the second output provides a neutral signal (e.g., a “low signal”) to the next stage to keep the backlight of the PDA on, for example.

If one or more PMOS transistors included in the light sensing circuit 100 has been damaged due to ESD/EOS, then sufficient leakage current flowing through resistor 111 may result in triggering the light sensing circuit 100 to turn off the backlight even if the ambient light is less than sufficient for viewing.

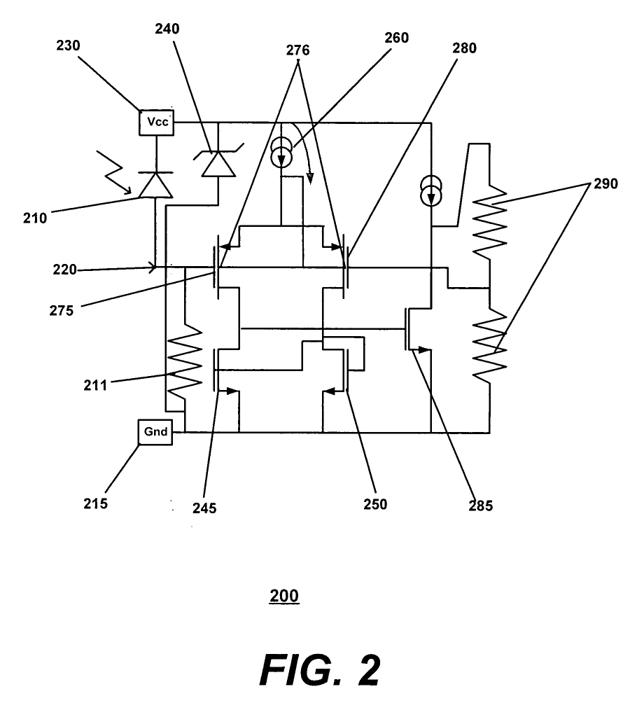

FIG. 2 shows a two-stage PMOS input trans-impedance amplifier 200 incorporating an embodiment of a protection circuit. The amplifier 200 may be incorporated into the light sensing circuit 100 of FIG. 1. The amplifier 200 includes a photodiode 210. The photodiode 210 may be a P-I-N diode, for example. If the photodiode 210 senses sufficient light, circuit 200 outputs a signal that may be used, for example, to turn off the backlight of a PDA. The photodiode 210 is coupled between a supply voltage (Vcc) 230 and the gate of PMOS transistor 275. A resistor 211 is coupled to the gate of the PMOS transistor 275 and ground (Gnd) 215. The PMOS transistor 275 is coupled to PMOS transistor 280, forming a differential pair.

The amplifier 200 further includes NMOS transistors 245, 250 and 285, current source 260, and an output stage including resistors 290.

Because the Vcc and Gnd connections are exposed to external conditions (e.g., the connections are tied to external pins), the Vcc and Gnd connections may be exposed to ESD/EOS. This exposure can damage transistors or other components susceptible to ESD/EOS.

As shown in FIG. 2, a zener diode 240 is placed between Vcc 230 and Gnd 215. The zener diode 240 prevents the Vcc 230 from exceeding a maximum voltage, thus protecting the photodiode 210. Specifically, if Vcc 230 exceeds the breakdown voltage of the zener diode 240, the zener diode 240 provides a short to Gnd 215, which protects the photodiode 210. Therefore, the maximum voltage that the photodiode 210 can be exposed to is limited and predetermined based on the breakdown voltage of the zener diode 240. Besides the photodiode 210, the zener diode 240 may protect other components in circuit 200, such as photodiode 210 and the transistors 275, 280, 245, 250, and 285, from over current, which may be caused by, for example, ESD/EOS.

In the embodiment shown in FIG. 2, the bulk (i.e., substrate) voltage of PMOS transistors 275, 280 is shorted to the source of the PMOS transistors 275, 280. In other words, the substrate voltage is biased with an internal known voltage that is less than the supply voltage Vcc. In this case, the output of the current source 260 is provided to both the source and substrate 276 of the PMOS transistors 275 and 280. This limits the voltage stress across the PMOS transistors 275 and 280 when point 220 is at ground potential. Isolating or shifting the substrate voltage away from the external exposed Vcc voltage limits the amount of voltage that the PMOS transistors 275 and 280 will be exposed to during ESD/EOS conditions. Isolating the transistors 275 and 280 from the exposed Vcc protects components of the circuit 200 from a sudden voltage spike that can be caused by ESD/EOS. The circuit configuration shown in FIG. 2 may help to protect PMOS transistors 275 and 280 from experiencing internal dielectric breakdown that can occur if the transistors such as PMOS transistors 275 and 280 are subjected to sudden voltage spikes.

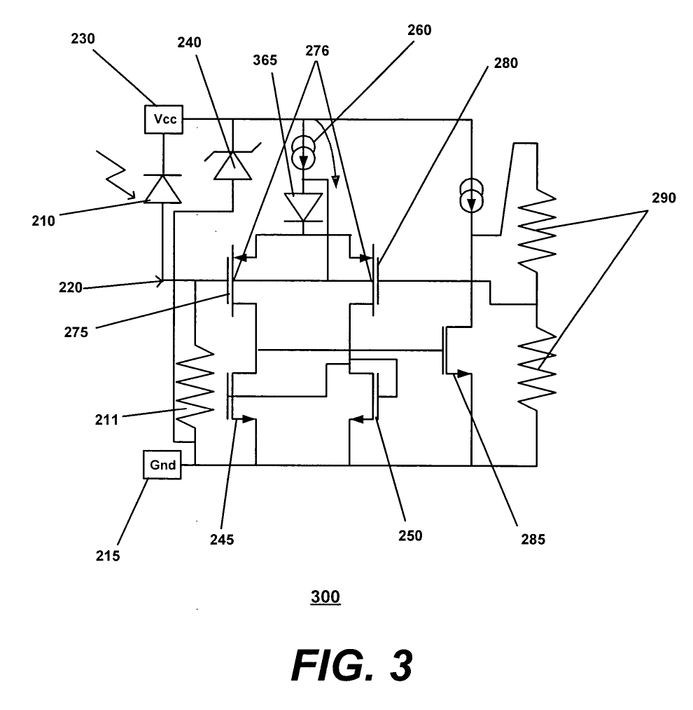

FIG. 3 shows a two-stage PMOS input trans-impedance amplifier incorporating an embodiment of a protection circuit 300, which is a modified configuration of the amplifier circuit 200 shown in FIG. 2. As can be seen in FIG. 3, a diode 365 is inserted between the current source 260 and the sources of the PMOS transistors 275 and 280. The output of the current source 260 (at the high side of the diode 365) is coupled to the substrate 276 of the PMOS transistors 275 and 280. By inserting the diode 365 and biasing the substrate 276 using the output of the current source 260, the substrate voltage of the PMOS transistors 275 and 280 is biased one diode 265 voltage above the source of the PMOS transistors 275 and 280. Isolating or shifting the substrate voltage away from the external exposed Vcc voltage limits the amount of voltage that the PMOS transistors 275 and 280 will be exposed to during ESD/EOS conditions. Isolating the transistors 275 and 280 from the exposed Vcc protects components of the circuit 300 from a sudden voltage spike that can be caused by ESD/EOS. The circuit configuration shown in FIG. 3 may help to protect PMOS transistors 275 and 280 from experiencing internal dielectric breakdown that can occur if the transistors such as PMOS transistors 275 and 280 are subjected to sudden voltage spikes.

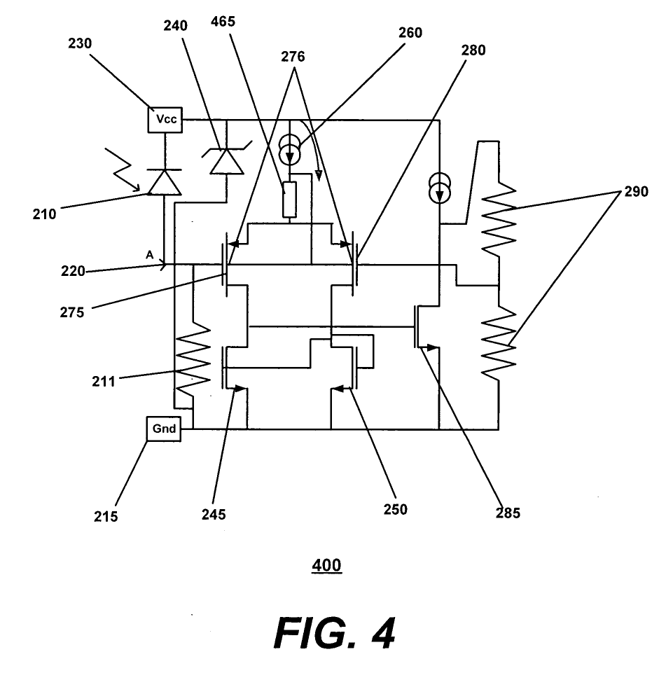

FIG. 4 shows a two-stage PMOS input trans-impedance amplifier incorporating an embodiment of a protection circuit 400, which is a modified configuration of the amplifier circuit 200 shown in FIG. 2. As can be seen in FIG. 4, a resistor 465 is inserted between the current source 260 and the sources of the PMOS transistors 275 and 280. The output of the current source 260 (at the high side of the resistor 465) is coupled to the substrate 276 of the PMOS transistors 275 and 280. By inserting the resistor 465 and biasing the substrate 276 using the output of the current source 260, the substrate voltage of the PMOS transistors 275 and 280 is biased one resistor 265 voltage above the source of the PMOS transistors 275 and 280. Isolating or shifting the substrate voltage away from the external exposed Vcc voltage limits the amount of voltage that the PMOS transistors 275 and 280 will be exposed to during ESD/EOS conditions. Isolating the transistors 275 and 280 from the exposed Vcc protects components of the circuit 400 from a sudden voltage spike that can be caused by ESD/EOS. The circuit configuration shown in FIG. 4 may help to protect PMOS transistors 275 and 280 from experiencing internal dielectric breakdown that can occur if the transistors such as PMOS transistors 275 and 280 are subjected to sudden voltage spikes.

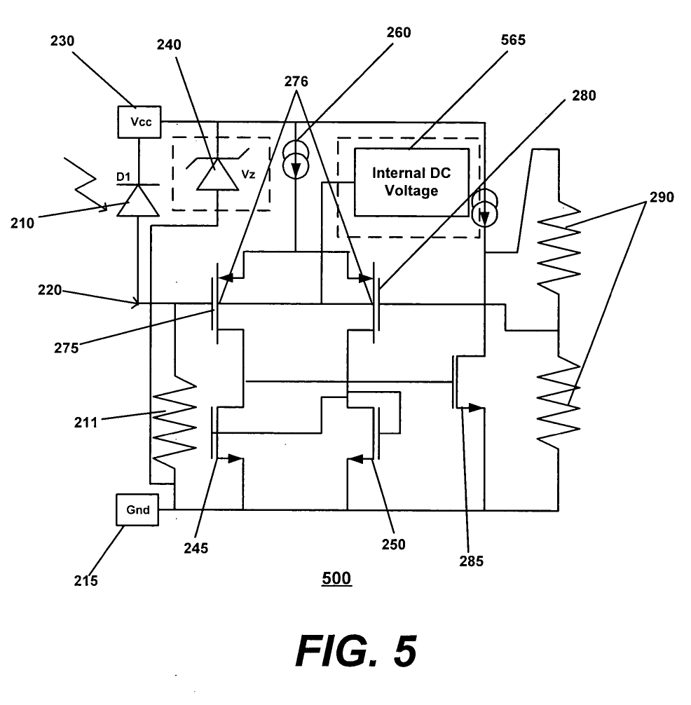

FIG. 5 shows a two-stage PMOS input trans-impedance amplifier incorporating an embodiment of a protection circuit 500, which is a modified configuration of the amplifier circuit 200 shown in FIG. 2. As can be seen in FIG. 5, an internal direct current (DC) voltage 565 is coupled to the substrate 276 of the PMOS transistors 275 and 280. The output of the current source 260 is coupled to the source of the PMOS transistors 275 and 280. The internal DC voltage 565, supplied to the substrate 276 of the PMOS transistors 275 and 280, may be greater than or equal to the voltage at the source of the PMOS transistors 275 and 280. The internal DC voltage 565 may be based on a predetermined voltage, for example, a bandgap voltage (i.e., Vbandgap) which is a standard reference voltage generated using the bandgap characteristics of a semiconductor.

The DC voltage 565 provided to the substrate 276 of the PMOS transistors 275 and 280 is isolated from Vcc 230 or external pins. Isolating the substrate voltage away from the external exposed Vcc voltage limits the amount of voltage that the PMOS transistors 275 and 280 will be exposed to during ESD/EOS conditions. Isolating the transistors 275 and 280 from the exposed Vcc protects components of the circuit 500 from a sudden voltage spike that can be caused by ESD/EOS. The circuit configuration shown in FIG. 5 may help to protect PMOS transistors 275 and 280 from experiencing internal dielectric breakdown that can occur if the transistors such as PMOS transistors 275 and 280 are subjected to sudden voltage spikes.

In the above-described embodiments, the substrate voltage of one or more transistors, such as the PMOS transistors, is isolated from the external voltage Vcc and biased using a predetermined voltage. Vcc is exposed to external pins that are susceptible to human ESD or EOS or other voltages (e.g., machine discharge). Biasing the PMOS transistor's substrate voltage to an internal predetermined voltage isolates the transistor's substrate from high voltage stresses caused by ESD or EOS. Additionally or optionally, as described herein, a zener diode may be installed between the Vcc and Gnd to provide a short to Gnd in the event Vcc exceeds the breakdown voltage of the zener diode. Biasing the substrate and/or installing a zener diode can help protect the components of a circuit from ESD or EOS.

What is claimed is:

1. A circuit for protection against electrostatic discharge and electrical over stress, comprising:
a first transistor including a substrate;
an internal predetermined voltage source, wherein the internal predetermined voltage source is used to bias the substrate of the first transistor, the internal predetermined voltage source is greater than or equal to a source voltage provided to a source of the first transistor and the internal predetermined voltage source isolates a substrate voltage of the first transistor from a supply voltage of the circuit;
a first resistor coupled to a gate of the first transistor and ground; and
a zener diode coupled between ground and the supply voltage of the circuit, wherein the zener diode shorts to ground if the supply voltage of the circuit exceeds a breakdown voltage of the zener diode.

2. The circuit of claim 1, further comprising:
a current source coupled to the substrate of the first transistor, wherein the current source isolates the substrate voltage from the supply voltage of the circuit and provides the internal predetermined voltage source.

3. The circuit of claim 2, wherein the current source is coupled to the source of the first transistor.

4. The circuit of claim 2, further comprising:
a diode coupled between the current source and the source of the first transistor.

5. The circuit of claim 2, further comprising:
a second resistor coupled between the current source and the source of the first transistor.

6. The circuit of claim 2, wherein the internal predetermined voltage is based on a bandgap voltage.

7. The circuit of claim 2, further comprising:
a photodiode coupled to the gate of the first transistor and the supply voltage of the circuit.

8. The circuit of claim 2, further comprising:
a second transistor coupled between a drain of the first transistor and ground.

9. A method for protection of a circuit from electrostatic discharge, comprising:
biasing a substrate of a transistor in the circuit with a predetermined internal voltage, wherein the predetermined internal voltage is greater than or equal to a source voltage provided to a source of the transistor and isolates a substrate voltage of the transistor from supply voltage of the circuit; and
providing a zener diode between ground and the supply voltage of the circuit, wherein the zener diode shorts to ground if the supply voltage of the circuit exceeds a breakdown voltage of the zener diode.

10. The method of claim 9, further comprising:
biasing the substrate of the transistor with a current source.

11. The method of claim 9, further comprising:
shifting the substrate bias by a predetermined amount above a voltage provided by an internal voltage source to a source of the transistor.

12. A circuit comprising:
a differential pair including a first transistor and a second transistor, wherein a substrate of the differential pair is biased by an internal voltage and wherein the internal voltage is greater than or equal to a source voltage provided to a source of the differential pair;
a photo diode coupled to a gate of the first transistor and to a Vcc of the circuit; and
a resistor coupled between the gate and ground.

13. The circuit of claim 12, further comprising:
a zener diode coupled between the ground and the Vcc of the circuit, wherein the zener diode is parallel to the photodiode and the resistor.

14. The circuit of claim 12, further comprising:
a internal source, wherein the internal voltage for biasing the substrate of the differential pair is provided by the internal source.

15. The circuit of claim 14, wherein the internal source is coupled to the source of the differential pair.

16. The circuit of claim 14, further comprising:
a second resistor coupled between the current source and the source of the differential pair.

17. The circuit of claim 12, wherein the internal voltage is based on a bandgap voltage.

18. The circuit of claim 12, further comprising:
a third transistor coupled between a drain of the first transistor and ground.

19. The circuit of claim 12, wherein the differential pair is a PMOS differential pair and wherein the first transistor is a PMOS transistor and the second transistor is a PMOS transistor.

20. A circuit for protection against electrostatic discharge and electrical over stress, comprising:
a transistor including a substrate;
a means for biasing the substrate of the transistor in the circuit with a predetermined internal voltage, wherein the predetermined internal voltage is greater than or equal to a source voltage provided to a source of the transistor and isolates a substrate voltage of the first transistor from a supply voltage of the circuit; and
a means for providing a short to ground if the supply voltage of the circuit exceeds a predetermined breakdown voltage, wherein the means for providing the short to ground and the means for biasing protects the transistor against electrostatic discharge and electrical over stress.
